(19) United States
(12) Patent Application Publication
(10) Pub. No.: US 2010/0213871 A1
(43) Pub. Date: Aug. 26, 2010

(54) BACKLIGHT DRIVING SYSTEM

(75) Inventors: WEI-HU CHEN, Shanghai City (CN); YI-HSUN LIN, Jhongli City (TW); YU-JU LIN, Jhongli City (TW); JING XIANG, Shanghai City (CN)

Correspondence Address: PCE INDUSTRY, INC.;ATT. Steven Reiss, 288 SOUTH MAYO AVENUE, CITY OF INDUSTRY, CA, 91789, US

(73) Assignees: AMLINK(SHANGHAI) LTD., Shanghai (CN); AMPOWER TECHNOLOGY CO., LTD., Jhongli City (TW)

(21) Appl. No.: 12/477,909

(22) Filed: Jun. 4, 2009

(30) Foreign Application Priority Data
Feb. 20, 2009 (CN) 200910105487.9

(51) Int. Cl. H05B 37/02

(52) U.S. Cl. 315/295

(57) ABSTRACT

A backlight driving system comprises a backlight driving circuit and a brightness regulation circuit. The brightness regulation circuit comprises a first regulation circuit to generate a first brightness regulation signal, a second regulation circuit to generate a second brightness regulation signal, a signal regulation circuit to combine the first and second brightness regulation signals into a combined brightness regulation signal according to a mode selection signal, and a driving control circuit to control the power delivered to the backlight from the backlight driving circuit according to the combined brightness regulation signal.

### BACKGROUND

1. Technical Field

Embodiments of the present disclosure relate to backlight driving systems, and particularly to a backlight driving system with a plurality of brightness regulation modes.

2. Description of Related Art

Often, brightness of a backlight is regulated either by user selection from a plurality of preset brightness grades, or based on an ambient brightness automatically.

When employing the former mode, the user makes a selection according to current ambient brightness, an inconvenient and often imprecise solution. Accordingly, a user may choose to avoid regulating the backlight at all due to the inconvenience, and rather operate in a relatively high brightness grade to allow viewing in different ambient brightness. Thus, power of the backlight is inevitably wasted.

When employing the automatic mode, an optical sensor detects the current ambient brightness and regulates the brightness of the backlight automatically. That is, the brightness of the backlight increases with ambient brightness, and decreases accordingly. However, the second mode may not provide sufficient illumination for all viewers' individual requirements, such as those with impaired or limited eyesight.

### BRIEF DESCRIPTION OF THE DRAWINGS

Many aspects of the embodiments can be better understood with references to the following drawings, wherein like numerals depict like parts, and wherein:

FIG. 1 is a block diagram of one embodiment of a backlight driving system of the present disclosure;

FIG. 2 is a block diagram of one embodiment of a brightness regulation circuit of a first embodiment of the present disclosure;

FIG. 3 is one embodiment of a detailed circuit diagram of FIG. 2;

FIG. 4 is a block diagram of another embodiment of a brightness regulation circuit of the present disclosure;

FIG. 5 is one embodiment of a detailed circuit diagram of FIG. 4;

FIG. 6 is a block diagram of another embodiment of a brightness regulation circuit of the present disclosure; and

FIG. 7 is one embodiment of a detailed circuit diagram of FIG. 6.

### DETAILED DESCRIPTION

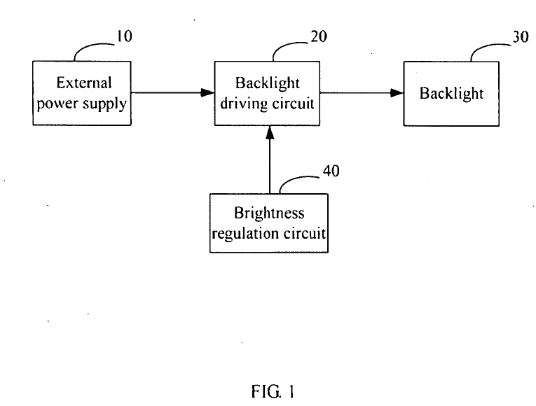

Referring to FIG. 1, a block diagram of one embodiment of a backlight driving system of the present disclosure is shown, which is used to drive a backlight 30 and comprises an external power supply 10, a backlight driving circuit 20, and a brightness regulation circuit 40. The backlight 30 may comprise cold cathode fluorescent lamps (CCFLs), light emitting diodes (LEDs), organic light-emitting diodes (OLEDs), or other commonly used lamps. The backlight driving circuit 20 receives electrical signals from the external power supply 10, and converts the electrical signals to alternating current (AC) signals to drive the backlight 30. The brightness regulation circuit 40 is connected to the backlight driving circuit 20, and operable to regulate output of the backlight driving system 20 according to a brightness regulation mode selected by users.

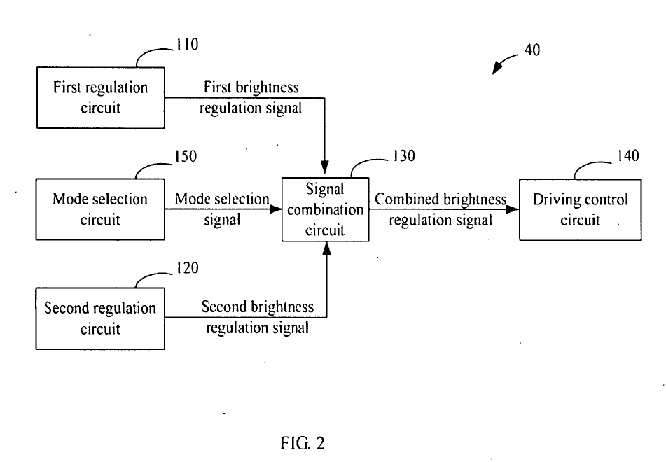

Referring to FIG. 2, a block diagram of the brightness regulation circuit 40 of another embodiment of the present disclosure is shown. The brightness regulation circuit 40 comprises a first regulation circuit 110, a second regulation circuit 120, a signal combination circuit 130, a driving control circuit 140 and a mode selection circuit 150. The first regulation circuit 110 outputs a first brightness regulation signal to the signal combination circuit 130. The second regulation circuit 120 outputs a second brightness regulation signal to the signal combination circuit 130. The mode selection circuit 150 outputs a logic high level signal (e.g., a logical 1) or a low logic level signal (e.g., a logical 0) indicative of a mode selection signal to the signal combination circuit 130 according to the selected brightness regulation mode. The signal combination circuit 130 combines the first and the second brightness regulation signals into a combined brightness regulation signal to the driving control circuit 140.

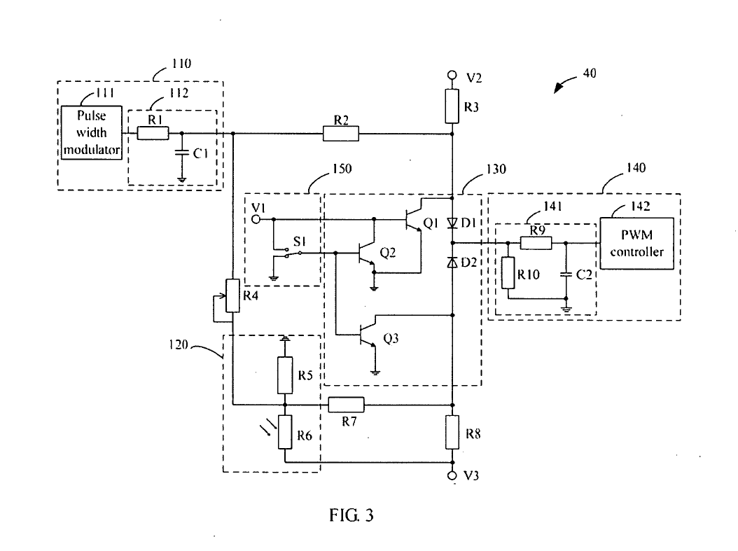

Referring to FIG. 3, one embodiment of a detailed circuit diagram of the brightness regulation circuit 40 of FIG. 2 is shown. In one embodiment, the first regulation circuit 110 comprises a pulse width modulator 111 and a filtering circuit 112. The pulse width modulator 111 outputs a square wave signal with an adjustable duty cycle. Users can obtain a desired brightness grade by regulating the duty cycle of the square wave signal. The filtering circuit 112 filters the square wave signal to a direct current (DC) signal, which comprises a resistor R1 and a capacitor C1. One end of the resistor R1 is connected to the pulse width modulator 111, and the other end thereof is connected to the signal combination circuit 130 via a resistor R2 as output of the first regulation circuit 110. The capacitor C1 is connected between the other end of the resistor R1 and ground. In one embodiment, the square wave signal provided by the pulse width modulator 111 of the first regulation 110 is filtered to a DC signal by the filtering circuit 112, and output to the signal combination circuit 130 as the first brightness regulation signal.

In one embodiment, the second regulation circuit 120 generates the second brightness regulation signal, which comprises a resistor R5 and a light dependent resistor R6. One end of the resistor R6 is connected to a reference voltage V3 and the other end thereof is grounded via the resistor R5. A junction of the resistor R5 and the light dependent resistor R6 is connected to the signal combination circuit 130 via a resistor R7 as an output of the second regulation circuit 120.

In one embodiment, the mode selection circuit 150 comprises a Single Pole Double Throw (SPDT) switch S1. The SPDT switch S1 comprises a common pole, a first throw pole and a second throw pole. The common pole of the SPDT switch S1 is connected to the signal combination circuit 130 as an output of the mode selection circuit 150, the first throw pole thereof is connected to a reference voltage V1, and the second throw pole thereof is grounded. Here, the mode selection circuit 150 outputs a high logic level signal as the mode selection signal, if the common pole of the SPDT switch S1 is connected to the first throw pole thereof. Conversely, the mode selection circuit 150 outputs a low logic level signal as the mode selection signal, if the common pole of the SPDT switch S1 is connected to the second throw pole thereof. In one embodiment, the high or low logic level signal is indicative of two kinds of brightness regulation modes selected by users. It is understood that the mode selection signal can be provided by other circuits capable of generating the high and low logic level signals.

The signal combination circuit 130 combines the first and second regulation signals into a combined brightness regulation signal according to the mode selection signal. The signal combination circuit 130 comprises a plurality of switch components Q1, Q2, Q3, and diodes D1 and D2. The switch component Q1 comprises a first electrode connected to the reference V1, a second electrode connected to a reference voltage V2 via a resistor R3 and a third electrode grounded. The switch component Q2 comprises a first electrode connected to the output of the mode selection circuit 150, a second electrode connected to the reference voltage V1 and a third electrode grounded. The third switch component Q3 comprises a first electrode connected to the output of the mode selection circuit 150, a second electrode connected to the reference voltage V3 via a resistor R8, and a third electrode grounded. In one embodiment, each of the switch components Q1, Q2 and Q3 comprises an npn transistor, the first electrode is a base, the second electrode is a collector, and the third electrode is an emitter. An anode of the diode D1 is connected to the second electrode of the switch component Q1 and receives the first brightness regulation signal via the resistor R2, and an anode of the diode D2 is connected to the second electrode of the switch component Q3 and receives the second regulation signal via the resistor R7. Cathodes of the diodes D1 and D2 are connected together as an output of the signal combination circuit 130 for outputting the combined brightness regulation signal.

The driving control circuit 140 regulates the output of the backlight driving circuit 20 according to the combined brightness regulation signal output by the signal combination circuit 130. The driving control circuit 140 comprises a surge limiter circuit 141 and a pulse width modulation (PWM) controller 142. The surge limiting circuit 141 limits surge of the combined brightness regulation signal caused by switching the brightness regulation modes, and comprises two resistors R9, R10 and a capacitor C2. One end of the resistor R9 is connected to the output of the signal combination circuit 130 and the other end thereof is connected to the PWM controller 142. The resistor R10 is connected between the one end of the resistor R9 and ground. The capacitor C2 is connected between the other end of the resistor R9 and ground.

In one embodiment, the brightness regulation circuit 40 comprises an adjustable resistor R4 connected between the output of the first regulation circuit 110 and the output of the second regulation circuit 120 to adjust a weight of the first or second brightness regulation signal in the combined brightness regulation signal.

In one embodiment, if the mode selection signal output from the mode selection circuit 150 is at a high logic level (for example, the common pole of the SPDT switch S1 is connected to the first throw pole thereof), the switch components Q2, Q3 and the diode D1 are on, and the switch component Q1 and the diode D2 are cut off. The first regulation circuit 110 outputs the first brightness regulation signal to the diode D1 via the resistor R2. The second regulation circuit 120 outputs the second brightness regulation signal to the diode D1 via the resistor R4 and R2 successively. The first and second brightness regulation signals are combined into the combined brightness regulation signal and delivered to the driving control circuit 140. The weight of the second brightness regulation signal in the combined brightness regulation signal can be determined by regulating the adjustable resistor R4.

If the mode selection signal output from the mode selection circuit 150 is at a low logic level (for example, the common pole of the SPDT switch S1 is connected to the second throw pole thereof), the switch components Q2, Q3 and the diode D1 are cut off, and the switch component Q1 and the diode D2 are on. The first regulation circuit 110 outputs the first brightness regulation signal to the diode D2 via the resistor R7 and R4 successively. The second regulation circuit 120 outputs the second brightness regulation signal to the diode D2 via the resistor R7. The first and second brightness regulation signals are combined into the combined brightness regulation signal and delivered to the driving control circuit 140. The weight of the first brightness regulation signal in the combined brightness regulation signal can be determined by regulating the adjustable resistor R4.

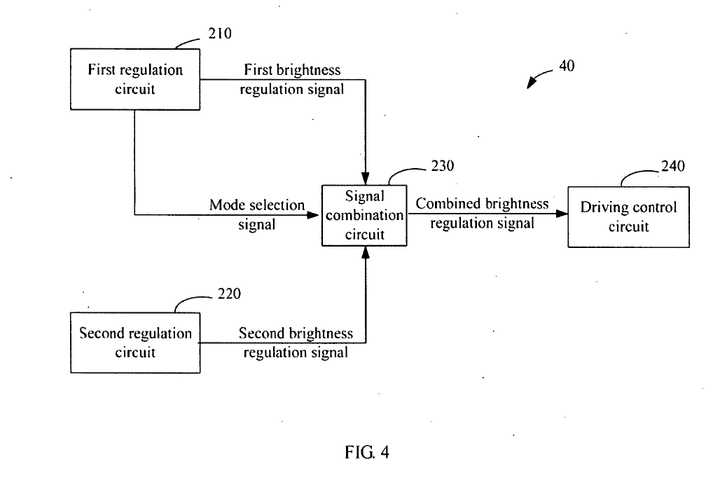

FIG. 4 is a block diagram of the brightness regulation circuit 40 of another embodiment of the present disclosure, differing from the brightness regulation circuit of FIG. 2 only in that the mode selection signal is generated by the first regulation circuit 210.

The first brightness regulation signal in FIG. 4 can also be provided by the first regulation circuit 120 as shown in FIG. 3.

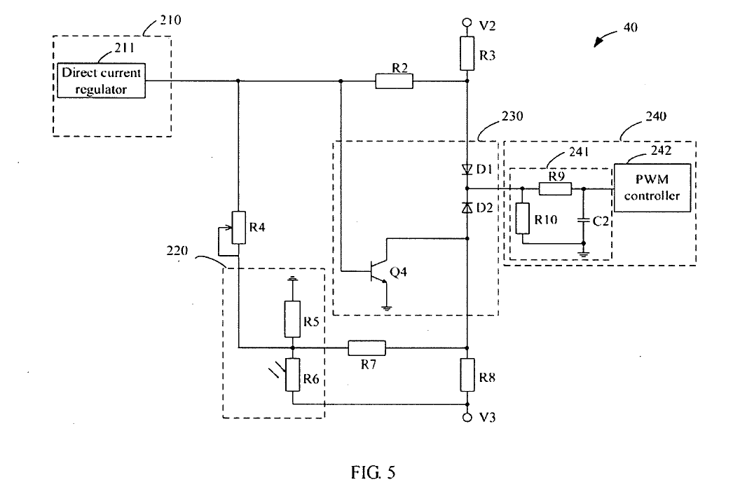

FIG. 5 is a detailed circuit diagram of FIG. 4. In one embodiment, the brightness regulation circuit 40 comprises a first regulation circuit 210, a second regulation circuit 220, a signal combination circuit 230 and a driving control circuit 240. The first regulation circuit 210 comprises only a DC regulator 211 to generate DC signals corresponding to the preset brightness grades as the first brightness regulation signal. The signal combination circuit 230 comprises a switch component Q4, two diodes D1 and D2. A first electrode of the switch component Q4 is connected to the output of the first regulation circuit 210 and is also connected to an anode of the diode D1 via a resistor R2. A second electrode of the switch component Q4 is connected to an anode of the diode D2, and a third electrode thereof is grounded. In one embodiment, the switch component Q4 comprises an npn transistor, the first electrode is a base, the second electrode is a collector, and the third electrode is an emitter. The anode of the diode D1 is also connected to a reference voltage V2 via a resistor R3, and the anode of the diode D2 is also connected to a reference voltage V3 via a resistor R8. Cathodes of diodes D1 and D2 are connected together as an output of the signal combination circuit 230 to output the combined brightness signal. The configuration and relation of the second regulation circuit 220 and the driving control circuit 240 in FIG. 5 are the same as those of the second regulation circuit 120 and the driving control 140 shown in FIG. 3, which can be omitted.

In one embodiment, the brightness regulation circuit 40 comprises an adjustable resistor R4 connected between the output of the first regulation circuit 210 and the output of the second regulation circuit 220. Users can determine the weight of the second brightness regulation signal in the combined regulation signal by regulating the adjustable resistor R4.

In one embodiment, if the first brightness regulation signal output by the first regulation circuit 210 is lower than a preset value, the switch component Q4 is off and the diodes D1 and D2 are on. The first regulation circuit 210 outputs the first brightness regulation signal to the diode D1 via the resistor R2. The second regulation circuit 220 outputs the second brightness regulation signal to the diode D2 via a resistor R7. The first and second brightness regulation signals are combined into the combined brightness regulation signal and delivered to the driving control circuit 240.

If the first brightness regulation signal output from the first regulation circuit 210 is higher than the preset value, the switch component Q4 and the diode D1 are on, and the diode D2 is off. The first regulation circuit 210 outputs the first brightness regulation signal to the diode D1 via the resistor R2, and the second regulation circuit 220 outputs the second brightness regulation signal to the diode D1 via the resistors R4 and R2 successively. The first and second brightness regulation signals are combined into the combined brightness regulation signal and delivered to the driving control circuit 240. The weight of the second brightness regulation signal in the combined brightness regulation signal can be determined by regulating the adjustable resistor R4.

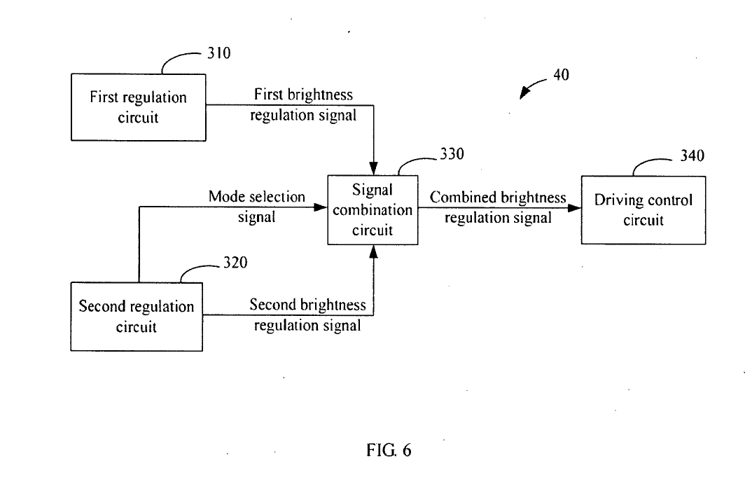

FIG. 6 is a block diagram of the brightness regulation circuit 40 of another embodiment of the present disclosure, differing from brightness regulation circuit 40 of FIG. 2 in that the mode selection signal is generated by the second regulation circuit 320.

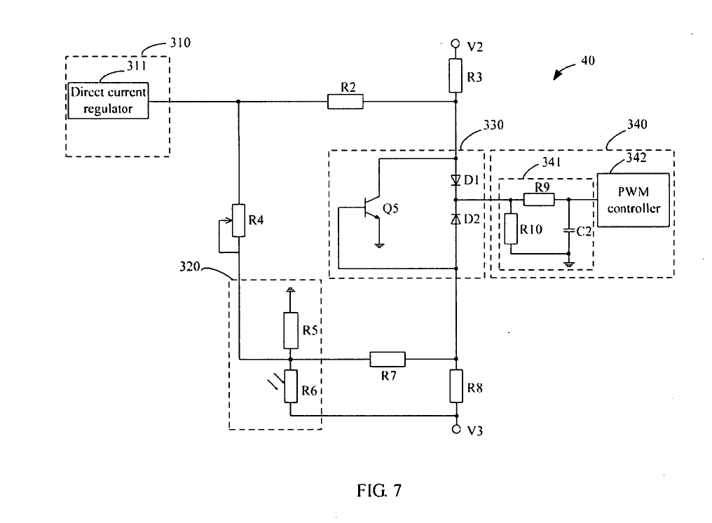

FIG. 7 is a detailed circuit diagram of FIG. 6. In one embodiment, the brightness regulation circuit 40 comprises a first regulation circuit 310, a second regulation circuit 320, a signal combination circuit 330 and a driving control circuit 340. The configurations and relations of the first regulation circuit 310, the second regulation circuit 320 and the driving control circuit 340 in FIG. 6 are the same with those of the first regulation circuit 110, the second regulation circuit 120 and the driving control circuit 140 of FIG. 3. The first brightness regulation signal in FIG. 6 can also be provided by the first regulation circuit 110 of in FIG. 3.

The signal combination circuit 330 comprises a switch component Q5, two diodes D1 and D2. A first electrode of the switch component Q5 is connected to an anode of the diode D2 and the output of the second regulation circuit 320 via a resistor R7. A second electrode of the switch component Q5 is connected to an anode of the diode D1, and a third electrode thereof is grounded. In one embodiment, the switch component Q5 is an npn transistor, the first electrode is a base, the second electrode is a collector, and the third electrode is an emitter. The anode of the diode D1 is connected to a reference voltage V2 via a resistor R3. The anode of the diode D2 is connected to a reference voltage V3 via a resistor R8. Cathodes of the diodes D1 and D2 are connected together as an output of the signal combination circuit 330 to output the combined brightness signal.

In one embodiment, the brightness regulation circuit 40 comprises an adjustable resistor R4 connected between the output of the first regulation circuit 310 and the output of the second regulation circuit 320. Users can determine the weight of the first brightness regulation signal in the combined regulation signal by regulating the adjustable resistor R4.

In one embodiment, if the second brightness regulation signal output by the second regulation circuit 320 is lower than a preset value, the diodes D1 and D2 are on. The first regulation circuit 310 outputs the first brightness regulation signal to the diode D1 via a resistor R2. The second regulation circuit 320 outputs the second brightness regulation signal to the diode D2 via a resistor R7. The combined brightness regulation signal is combined into the first and second brightness regulation signals and delivered to the driving control circuit 340.

If the first brightness regulation signal output from the first regulation circuit 320 is higher than the preset value, the diode Q5 and the diode D2 are on, and the diode D1 is off. The second regulation circuit 320 outputs the first brightness regulation signal to the diode D2 via the resistor R7. The first regulation circuit 310 outputs the first brightness regulation signal to the diode D2 via the resistors R4 and R7 successively. The first and second brightness regulation signals are combined into the combined brightness regulation signal and delivered to the driving control circuit 340. The weight of the first brightness regulation signal in the combined brightness regulation signal can be determined by regulating the adjustable resistor R4.

It should be noted that the reference voltages V1, V2 and V3 set forth can be equal or provided by a power source, and the preset value set forth can be set beforehand and adjusted at any time.

The present disclosure provides a backlight driving system with a plurality of brightness regulation modes. As such, users can easily realize power conservation and personal brightness regulation modes according their different requirements by setting the mode selecting signal as high or low logic level (for example, connecting the common pole of the SPDT switch S1 to the first or second throw pole thereof), or presetting and adjusting the preset value, and determining the weight of the first brightness regulation signal or the second brightness regulation signal in the combined brightness regulation signal by regulating the adjustable resistor R4.

It is believed that the present embodiments and their advantages will be understood from the foregoing description, and it will be apparent that various and more than two brightness regulation circuits may be made thereto without departing from the spirit and scope of the present disclosure, the examples hereinbefore described merely being preferred or exemplary embodiments of the present disclosure.

What is claimed is:

1. A backlight driving system, comprising:
a backlight driving circuit;
a brightness regulation circuit, comprising:
a first regulation circuit to generate a first brightness regulation signal;
a second regulation circuit to generate a second brightness regulation signal;
a signal combination circuit to combine the first brightness regulation signal and the second brightness regulation signal into a combined brightness regulation signal according to a mode selection signal; and
a driving control circuit to adjust output of the backlight driving circuit according to the combined brightness regulation signal.

2. The backlight driving system as claimed in claim 1, wherein the brightness regulation circuit comprises an adjustable resistor connected between an output of the first regulation circuit and an output of the second regulation circuit, to regulate weights of the first and second brightness regulation signals in the combined brightness regulation signal.

3. The backlight driving system as claimed in claim 2, wherein the brightness regulation circuit further comprises a mode selection circuit to generate the mode selection signal with a high or a low logic level.

4. The backlight driving system as claimed in claim 3, wherein the mode selection circuit comprises a single pole double throw switch with a common pole connected to the signal combination circuit to output the mode selection signal, a first throw pole connected to a first reference voltage and a grounded second throw pole.

5. The backlight driving system as claimed in claim 3, wherein the signal combination circuit comprises:
a first diode comprising an anode connected to the output of the first regulation circuit and a second reference voltage;
a second diode comprising an anode connected to the output of the second regulation circuit and a third reference voltage;
a first switch component comprising a first electrode connected to the first reference voltage, a second electrode connected to the anode of the first diode and a third electrode grounded;
a second switch component comprising a first electrode connected to the common pole of the SPDT switch, a second electrode connected to the first reference voltage and a third electrode grounded; and
a third switch component comprising a first electrode connected to the common pole of the SPDT switch, a second electrode connected to the anode of the second diode and a third electrode grounded;
wherein cathodes of the first diode and the second diode are connected together as an output of the signal combination circuit.

6. The backlight driving system as claimed in claim 5, wherein the first and second and third switch components each comprise an npn transistor.

7. The backlight driving system as claimed in claim 2, wherein the signal combination circuit comprises:
a first diode comprising an anode connected to the output of the first regulation circuit and a second reference voltage;
a second diode comprising an anode connected to the output of the second regulation circuit and a third reference voltage; and
a fourth switch component comprising a first electrode connected to the output of the first regulation circuit, a second electrode connected to the anode of the second diode and a third electrode grounded;
wherein cathodes of the first diode and the second diode are connected together as an output of the signal combination circuit.

8. The backlight driving system as claimed in claim 7, wherein the fourth switch component comprise an npn transistor.

9. The backlight driving system as claimed in claim 2, wherein the signal combination circuit comprises:
a first diode comprising an anode connected to the output of the first regulation circuit and a second reference voltage;
a second diode comprising an anode connected to the output of the second regulation circuit and a third reference voltage; and
a fifth switch component comprising a first electrode connected to the output of the second regulation circuit, a second electrode connected to the anode of the first diode and a third electrode grounded;
wherein cathodes of the first diode and the second diode are connected together as an output of the signal combination circuit.

10. The backlight driving system as claimed in claim 9, wherein the fifth switch component comprise an npn transistor.

11. The backlight driving system as claimed in claim 1, wherein the first regulation circuit comprises:
a pulse width modulator to generate a square wave signal with adjustable duty cycle;
a filtering circuit to filter the square wave signal to a direct current (DC) signal, output to the signal combination circuit as the first brightness regulation signal.

12. The backlight driving system as claimed in claim 11, wherein the filtering circuit comprises:
a first resistor with one end connected to the pulse width modulator and the other end outputting the first brightness regulation signal;
a first capacitor connected between the other end of the first resistor and ground.

13. The backlight driving system as claimed in claim 1, wherein the first regulation circuit comprises a direct current (DC) regulator arranged to generate DC signals corresponding to different brightness grades as the first brightness regulation signals.

14. The backlight driving system as claimed in claim 1, wherein the second regulation circuit comprises a light dependent resistor with one end connected to a third reference voltage and the other end grounded via a second resistor, and outputs the second brightness regulation signal corresponding to an ambient brightness.

15. The backlight driving system as claimed in claim 1, wherein the driving control circuit comprises:
a surge limiting circuit connected to the output of the signal combination circuit to limit surge of the brightness regulation signal; and
a pulse width modulation (PWM) controller connected to the surge limiting circuit to regulate the output of the backlight driving circuit according to the brightness regulation signal.

16. A backlight driving system that drives backlights comprising an external power supply, a backlight driving circuit, and a brightness regulation circuit, wherein the brightness regulation circuit comprises:
a plurality of regulation circuits to generate a plurality of brightness regulation signals respectively;
a signal combination circuit to combine the brightness regulation signals into a combined brightness regulation signal according to a mode selection signal received; and
a driving control circuit to regulate the output of the backlight driving circuit according to the combined brightness regulation signal.

17. The backlight driving system as claimed in claim 16, wherein the brightness regulation circuit comprises an adjustable resistor connected among the brightness regulation circuits to regulate weight of the brightness regulation signals in the combined brightness signal.

18. The backlight driving system as claimed in claim 17, wherein the brightness regulation circuit further comprises a mode selection circuit to generate the mode selection signal with a high or a low logic level.

19. The backlight driving system as claimed in claim 18, wherein the mode selection circuit comprises a single pole double throw switch with a common pole connected to the signal combination circuit to output the mode selection signal, a first throw pole connected to a first reference voltage and a grounded second throw pole.

20. The backlight driving system as claimed in claim 16, wherein the driving control circuit comprises:
a surge limiting circuit connected to the output of the signal combination circuit to limit surge of the brightness regulation signal; and
a pulse width modulation (PWM) controller connected to the surge limiting circuit to regulate the output of the backlight driving circuit according to the brightness regulation signal.
